(19) United States
(12) Patent Application Publication
(10) Pub. No.: US 2024/0281562 A1
(43) Pub. Date: Aug. 22, 2024

(54) MAINTAINING CONFIDENTIALITY OF PERSONAL DATA IN DOCUMENTS REQUIRED TO BE FILED BY GOVERNMENTAL REQUIREMENTS

(71) Applicant: FinCEN Report Company, LLC, Atlanta, GA (US)

(72) Inventors: Jonathan B. Wilson, Marietta, GA (US); Greg Frame, Nokomis, FL (US); Kenneth L. Gavranovic, Alpharetta, GA (US)

(21) Appl. No.: 18/582,495

(22) Filed: Feb. 20, 2024

Related U.S. Application Data
(60) Provisional application No. 63/447,480, filed on Feb. 22, 2023.

(51) Int. Cl. G06F 21/62; H04W 12/08

(52) U.S. Cl. CPC G06F 21/6245; H04W 12/08

(57) ABSTRACT

Methods, systems, and computer-readable media for facilitating individuals and organizations to comply with governmental reporting requirements while securing confidentiality and secrecy of individual's personally identifiable information (“PII”). A method comprises receiving company information comprising contact information for one or more individuals associated with a company from a company administrator. Each of the individuals is invited to access the system and provide PH corresponding to the individual. The provided PH is stored in a data storage such that it may be viewed and modified by the corresponding individual but may not be viewed by the company administrator or another individual associated with the company. Upon receiving PH corresponding to each of the individuals associated with the company, a governmental requirements report is generated in a format compliant with governmental requirements, the governmental requirements report comprising the PII corresponding to each of the one or more individuals associated with the company.

### CROSS-REFERENCE TO RELATED APPLICATIONS

This application claims the benefit of U.S. Provisional Application No. 63/447,480, filed on Feb. 22, 2023, and entitled “MAINTAINING CONFIDENTIALITY OF PERSONAL DATA IN DOCUMENTS REQUIRED TO BE FILED BY GOVERNMENTAL REQUIREMENTS,” the entire disclosure of which is hereby incorporated herein by this reference.

### BACKGROUND

### Field of the Invention

This disclosure relates to computing systems for providing governmental reporting functions. Specifically, this disclosure relates to systems, methods, computer-readable media, and user interfaces for the collection of personally identifiable information by an organization for governmental requirements reporting while maintaining the confidentiality of the information.

### Background of the Prior Art

Laws and other governmental mandates (referred to herein collectively as “governmental requirements”) may require individuals and corporate entities to disclose to the government certain personally identifiable information (“PII”) regarding individual natural persons (each, an “individual”). A problem arises where an individual is subject to a governmental requirement that requires disclosure to the government of the individual's PII but the individual wishes to maintain the secrecy of their PII from other individuals who are also subject to a governmental requirement. Another problem arises where a governmental requirement requires that a collective organization, like a corporation, partnership, limited liability company, or other legal entity, report to the government changes in PII with respect to an individual who is an owner or affiliate of the collective organization. individuals are rightfully concerned with the confidentiality and secrecy of their PII. An individual's PII may be utilized by illicit actors to engage in identify theft and related financial crimes to the detriment of the individual and society at large.

There is a need for a methodology to facilitate individuals and collective organizations to comply with governmental requirements while simultaneously securing the confidentiality and secrecy of each individual's PII.

### BRIEF SUMMARY

The present disclosure relates to technologies for providing a governmental requirements reporting system that facilitates individuals and collective organizations to comply with government reporting requirements while simultaneously securing the confidentiality and secrecy of each individual's PII. According to some embodiments, a method comprises receiving by the governmental requirements reporting system company information comprising contact information for one or more individuals associated with a company from a company administrator. Each of the one or more individuals associated with the company is invited to access the governmental requirements reporting system and provide personally identifiable information. The personally identifiable information corresponding to each individual is received from the corresponding individual and stored in a data storage of the governmental requirements reporting system. The received personally identifiable information is stored in the data storage such that it may be viewed and modified by the corresponding individual but may not be viewed by the company administrator or another of the one or more individuals associated with the company. Upon receiving personally identifiable information corresponding to each of the one or more individuals associated with the company, a governmental requirements report is generated by the governmental requirements reporting system in a format compliant with governmental requirements, the report comprising the personally identifiable information corresponding to each of the one or more individuals associated with the company.

In further embodiments, a non-transitory computer-readable medium is encoded with computer-executable instructions that, when executed by processing resources of a computing system; cause the computing system to receive company information comprising contact information for one or more individuals associated with a company from an administrator associated with the company. Each of the one or more individuals is electronically invited to access the governmental requirements reporting system. Personally identifiable information corresponding to each of the one or more individuals associated with the company is received by the computing system from the corresponding individual and stored in a data storage operably connected to the computing system. The received personally identifiable information is stored in the data storage such that it may be viewed and modified by the corresponding individual but may not be viewed by the administrator any of the other individuals associated with the company. Upon receiving approval from the administrator, a governmental requirements report containing the personally identifiable information corresponding to each of the one or more individuals associated with the company is generated in a format compliant with governmental requirements, and the generated governmental requirements report is electronically sent to an electronic governmental report submission system over the Internet.

According to further embodiments, a system comprises a data storage, a client app configured to execute on individual computing devices, and a cloud computing resource operatively connected to the data storage and connected to the client app executing on a plurality of individual computing devices through one or more networks. The cloud computing resource is configured to receive via the client app company information from an administrator associated with a company, the company information comprising contact information for one or more individuals associated with the company. An email is sent to each of the one or more individuals associated with the company based on the contact information for the individual, the email comprising a link allowing the individual to access the cloud computing resource via the client app. An individual provides via the client app personally identifiable information corresponding to the individual and the personally identifiable information is stored in the data storage in such a way that it may be viewed and modified via the client app by the corresponding first individual but may not be viewed by the administrator or another of the individuals associated with the company. Upon receiving the personally identifiable information corresponding to each of the one or more individuals associated with the company, a governmental requirements report comprising the personally identifiable information corresponding to each of the one or more individuals associated with the company is generated in a format compliant with governmental requirements.

These and other features and aspects of the various embodiments will become apparent upon reading the following Detailed Description and reviewing the accompanying drawings.

### BRIEF DESCRIPTION OF THE DRAWINGS

In the following Detailed Description, references are made to the accompanying drawings that form a part hereof, and that show, by way of illustration, specific embodiments or examples. The drawings herein are not drawn to scale, and any measurements provided are shown to provide a relative size context and are not intended to be limiting. Like numerals represent like elements throughout the several figures.

FIG. 1A is a system diagram showing the components of a governmental requirements reporting system, according to embodiments presented herein.

FIG. 1B is a block diagram showing further details of data structures of the governmental requirements reporting system along with visibility of various users and entities to the data structures, according to embodiments presented herein.

FIG. 2 is a flow chart showing an exemplary routine facilitating individuals and collective organizations to comply with governmental requirements while simultaneously securing the confidentiality and secrecy of each individual's PII, according to embodiments presented herein.

FIGS. 3A-3J are GUI diagrams showing an exemplary user interface used by individuals and/or administrators to interact with the governmental requirements reporting system, according to embodiments presented herein.

FIG. 4 is a block diagram showing an exemplary computing and software architecture for computing devices described herein.

### DETAILED DESCRIPTION

Several legal systems in the U.S. require individuals and companies to submit PII of individuals to government agencies. One example of such a governmental requirement is the Corporate Transparency Act of 2020 (“CTA”). The CTA requires the Financial Crimes Enforcement Network of the U.S. Treasury (“FinCEN”) to collect “beneficial ownership reports” submitted by U.S. companies. It must then build a beneficial ownership database that will be confidential, but available to law enforcement and financial institutions based upon regulations to be issued by FinCEN. The purpose of the CTA was to build a database of company ownership to aid law enforcement in fighting money laundering.

According to the rules promulgated by FinCEN under the CTA, any reporting company formed after the effective date must file its first beneficial ownership report within 30 calendar days after it is formed. Any pre-existing reporting company will have one year after the effective date to file a first report. The rules require each reporting company to file a beneficial ownership report that includes five items of personally identifiable information (“PII”) for each beneficial owner of the company: (1) full legal name, (2) date of birth, (3) residential address, (4) a “unique identifying number,” and (5) an image file of the document that contains the beneficial owner's picture and the unique identifying number (referred to herein as “identifying document”).

After the initial report is filed, if any item of previously reported data changes, the reporting company must file an amendment with the data change within 30 calendar days after the date of the change. Because the purpose of the CTA is to fight money laundering, there are steep penalties for failures to comply. A failure to file on time may result in a $500 per day fine, up to a maximum fine of $10,000. A willful failure to file (or willfully filing false information) may be punished as a felony by up to two years imprisonment. CTA violations that take place in connection with other financial crimes (such as money laundering) can result in enhanced penalties of up to ten years imprisonment.

The rules define “beneficial owner” as an individual who either (a) owns 25% or more of the beneficial ownership interest in the reporting company, or (b) exercises “substantial control”. The term, “substantial control” is defined in a complex facts and circumstances test that will include a reporting company's senior officers, directors and ownership who have the ability to influence important decisions of the reporting company. In the context of an LLC operating agreement where members have the ability to vote on important decisions, this definition could bring every member of the company into the scope of a “beneficial owner,” even where the member's ownership percentage is less than 25%.

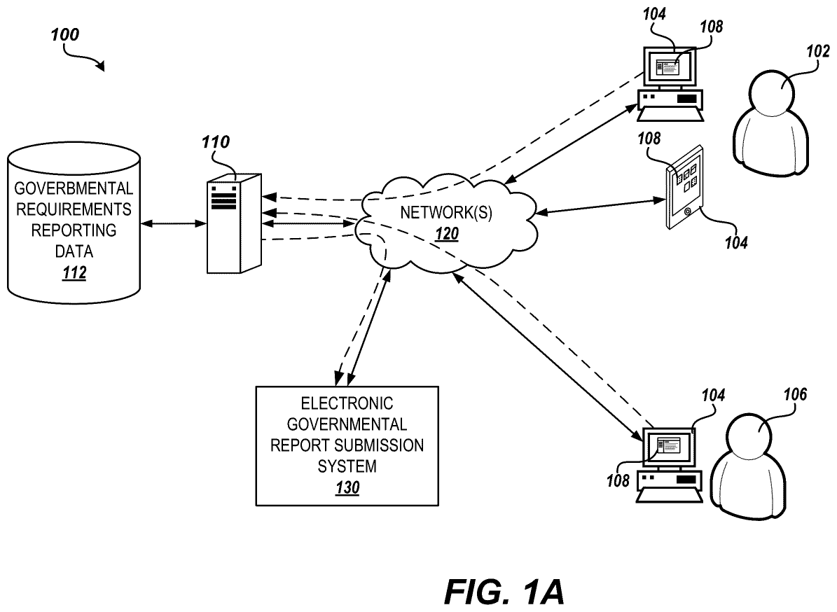

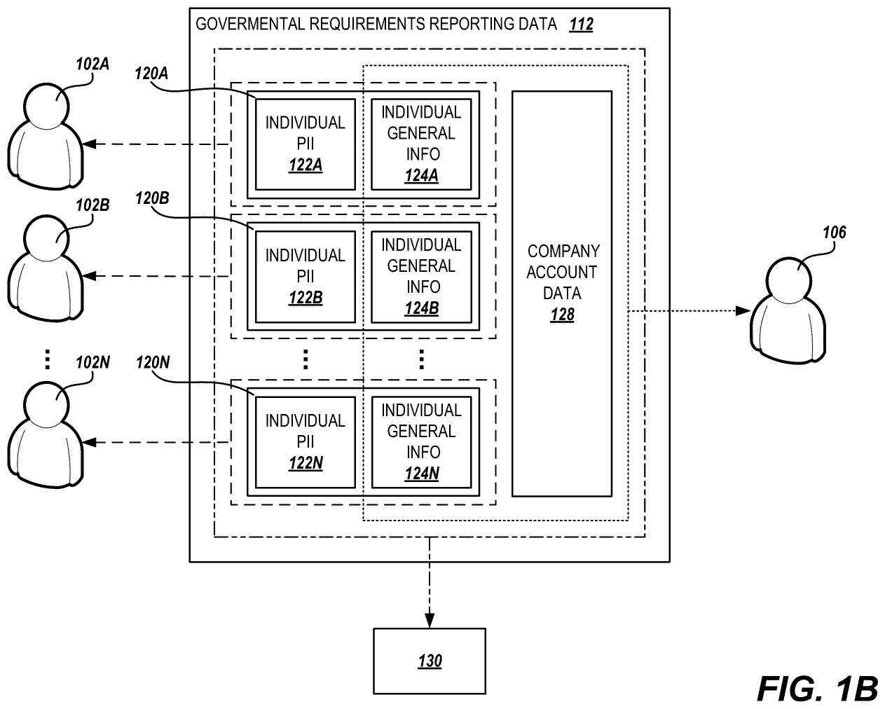

According to embodiments, a governmental requirements reporting system may be implemented that facilitates compliance with governmental reporting rules, such as those promulgated by FinCEN under the CTA, while maintaining the secrecy and confidentiality of each individual's PII. The governmental requirements reporting system consists of software and related databases that are housed on servers available over the Internet. FIG. 1A shows an exemplary governmental requirements reporting system 100, according to embodiments.

The governmental requirements reporting system 100 allows an individual 102 to connect to one or more cloud-based servers 110 over one or more networks 120 and create a secure individual account to contain their general info and PII. The individual 102 may utilize a computing device 104 to connect to the cloud-based server(s) 110 over the network(s) 120. The computing device 104 may represent any computing device, components, or systems that allow the individual 102 to access the functions of the governmental requirements reporting system 100, such as a mobile computing device, laptop or desktop computer, and the like. The computing device 104 may execute a client app 108 to access the governmental requirements reporting system 100. The client app 108 may comprise a mobile app executing on a mobile computing device, client-side portions of a web application executing in a web browser of a laptop or desktop computer, and the like. The network(s) 120 may comprise any combination of networking infrastructure that connects the computing device 104 to the cloud-based server(s) 110, such as LANs, WANs, 5G or LTE cellular data networks, and/or the Internet. The cloud-based server(s) 110 may represent virtualized computing resources available in the cloud, such as Amazon EC2 Cloud Computing services. In further embodiments, the cloud-based server(s) 110 may represent one or more of conventional web server, application server, and/or other application hosting environments executing on one more server computers.

The general info and PII for the individual 102 are stored in a database 112. An individual 102 may edit the account info and PII in their individual account at any time. The governmental requirements reporting system 100 may encrypt the data in the individual account. The individual account is accessible through a login name and password known only to the individual 102.

Individuals 102 and/or administrators 106 responsible for ensuring compliance with governmental reporting requirements for one or more companies or other organizations may create company accounts for the company(s). According to some embodiments, administrators 106 may create an unlimited number of company accounts and may collaborate with an unlimited number of related individuals 102 based on their legal interest in the applicable reporting company(s).

The administrator 106 may identify the beneficial owners for a company account in the governmental requirements reporting system 100 by basic contact information, such as name and email. The governmental requirements reporting system 100 may then utilize the basic contact information to notify each beneficial owner that they have been so designated, such as through an email invitation containing a link to the governmental requirements reporting system 100. The beneficial owners (individuals 102) may utilize the link to access the governmental requirements reporting system, create accounts, provide individual general information and PII, and provide consent to have their PII included in the company's required reports. The administrator 106 may have access to the status, general information, and consent provided by each individual 102 in the company account data as well as whether, e.g., identifying document(s) have been provided. The administrator 106 will not be able to see, however, the individual's PII. If the individual 102 does not consent, that fact will appear in the company account data. The administrator 106 may be prompted to consult an attorney to deal with any non-compliant individual 102.

According to embodiments, the governmental requirements reporting system 100 further has the capability to format the information stored for the company members (individuals 102), including each individual's PII, in the necessary format for governmental filings required by the government and, upon approval by the administrator 106 and/or the company's attorney, submit the filings securely over the networks 120 to an electronic governmental report submission system 130. In further embodiments, the governmental requirements reporting system 100 may facilitate paper based filings for compliance with the government reporting requirements.

FIG. 1B shows additional details of data structures in the governmental requirements reporting data 112 described above in addition to the visibility of individuals 102 and/or the administrator 106 to the information. As may be seen in the figure, data in the governmental requirements reporting data 112 associated with a particular company may include individual accounts, such as individual accounts 120A-120N (referred to herein generally as individual account 120), corresponding to a number of individuals, e.g., the beneficial owners of the company, such as individuals 102A-102N, respectively. Each individual account, such as individual account 120A, may include general individual info 124A (e.g., name, contact address and/or email, etc.) and individual PII 122A (e.g., legal name, date of birth, residential address, unique identifying number, identifying document(s), etc.) for the corresponding individual 102A. The governmental requirements reporting data 112 may further include company account data 128 associated with the company. The company account data 128 may include general company info (e.g., company name, company type, organization state, company ID, company address, etc.), a list of related individuals 102 and their roles (e.g., company members including beneficial owners, company administrator, billing contact, registered agent, etc.), the consent of each beneficial owner, the status of provision of identifying documents for each beneficial owner, and the like.

As further shown in the figure, according to embodiments, the governmental requirements reporting system 100 is configured such that an individual 102A-102N may view and edit the data in their respective individual account 102A-102N, including their individual general information 124A-124N (referred to herein generally as individual general information 124) and their PII 122A-122N (referred to herein generally as individual PII 122). In further embodiment, individuals 102A-102N (e.g. company members) may additionally have visibility to the company account data 128 associated with the company at varying levels of access based on the individual's role within the company. The administrator 106 may view and edit the company account data 128 and have some visibility to the individual general information 124A-124N of the respective individuals 102A-102N. However, neither the administrator 106 nor any other individual 102B-102N may view the individual PII 122A of a specific individual 102A. Only the corresponding individual 102A has visibility to their individual PII 122A. It will be appreciated by one skilled in the art upon reading this disclosure that the restrictions on visibility to the individual general information 124 and PII 122 in the individual accounts 120 and to the company account data 128 by the administrator 106 and the individuals 102 associated with a company may be accomplished by any number of combinations of application design, application security, and data security. It is intended that this disclosure support all such combinations of application design, application security, and data security.

The governmental requirements reporting system 100 is further configured to collectively access the company account data 128 and the individual general information 124A-124N and individual PII 122A-122N of the respective individuals 102A-102N comprising the company members in order to generate the necessary governmental filings and, upon approval by the administrator 106 and/or the company's attorney, submit the filings securely over the networks 120 to the electronic governmental report submission system 130. In further embodiments, the governmental requirements reporting system 100 may be configured to detect a change to certain data in an individual account, such as individual account 120A, made by the corresponding individual 102A. For example, the individual 102A may update their residence address or add or update an identifying document in their individual PII 122A. Upon detecting the change to the individual account data, the governmental requirements reporting system 100 may automatically notify the company administrator 106, and, depending on the nature of the governmental requirements, the administrator may thereafter cause the governmental requirements reporting system to generate and submit additional governmental filing(s) to the electronic governmental report submission system 130 as required by the governmental requirements in light of the data changed in the individual account 120A.

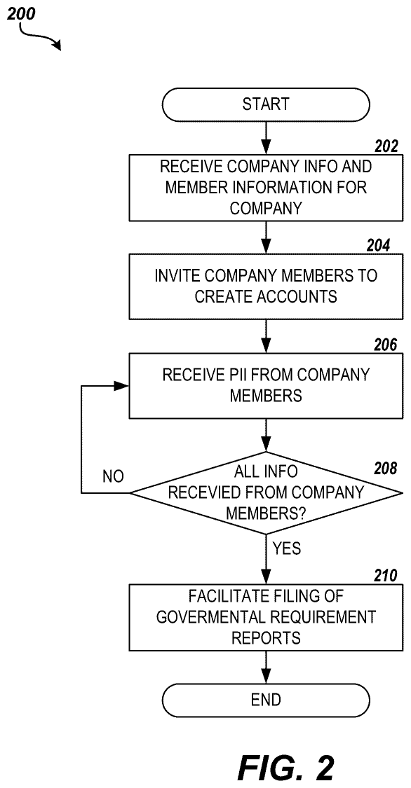

FIG. 2 illustrates one routine 200 for facilitating individuals and collective organizations to comply with governmental requirements while simultaneously securing the confidentiality and secrecy of each individual's PII, according to embodiments described herein. In some embodiments, the steps of the routine 200 may be performed by software and hardware in the governmental requirements reporting system 100 described above in regard to FIG. 1. In other embodiments, the routine 200 may be performed by some combination of personal computing devices 104, cloud-based servers 110, and/or other computing devices, components, and modules of the governmental requirements reporting system 100.

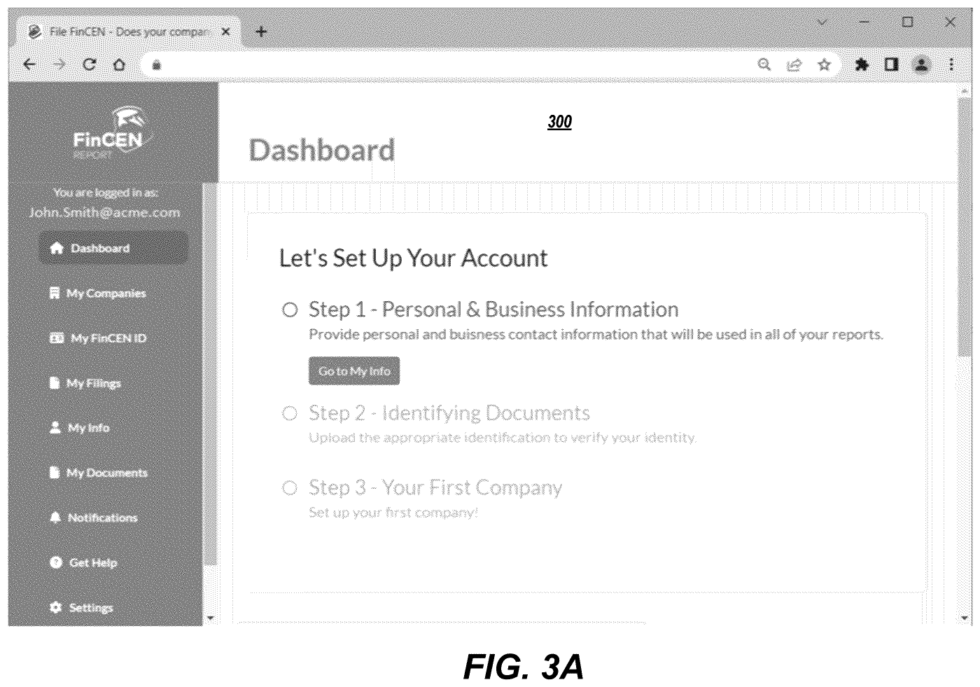

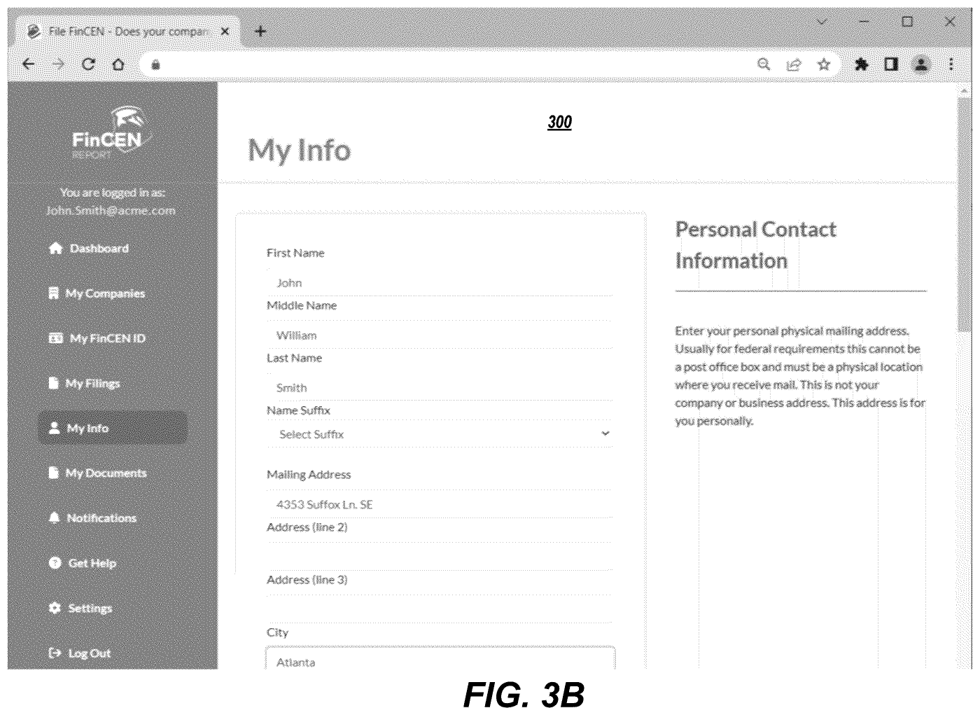

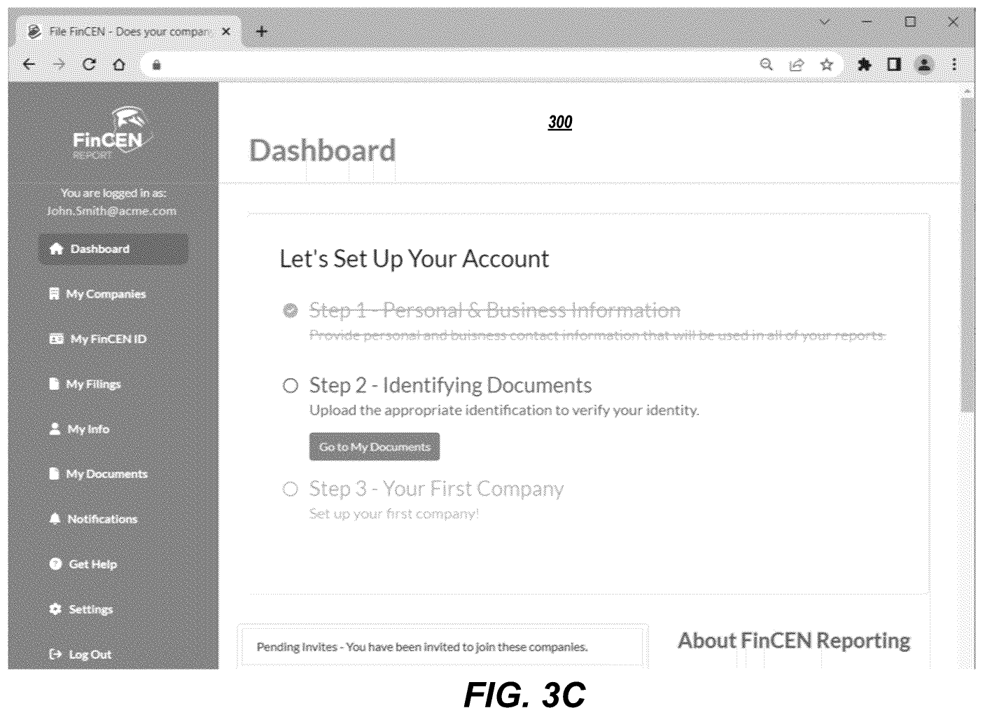

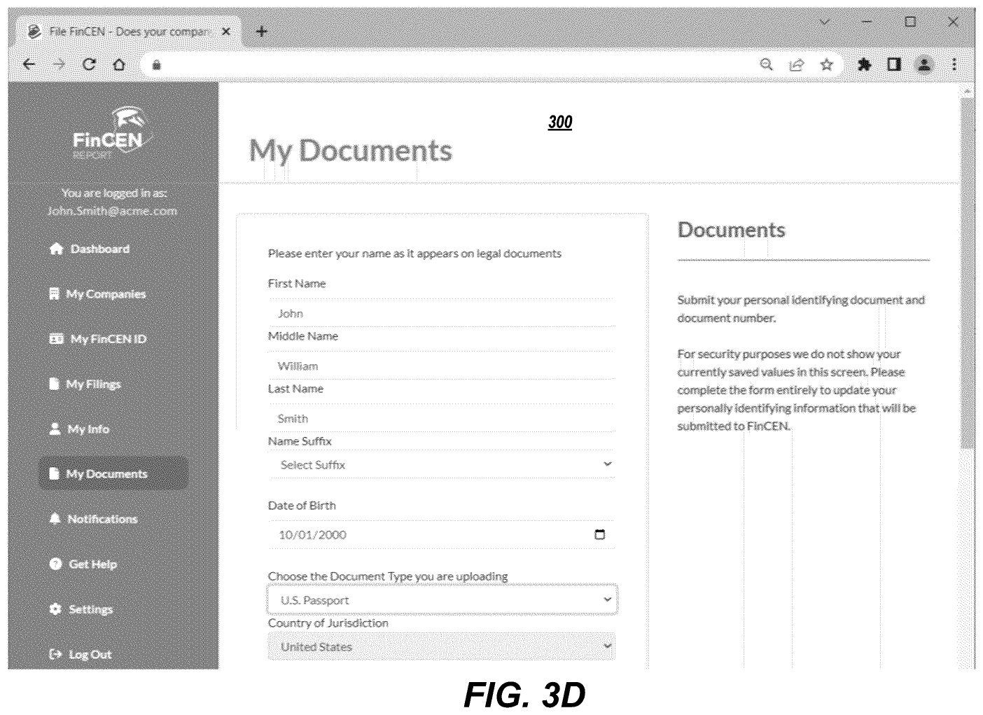

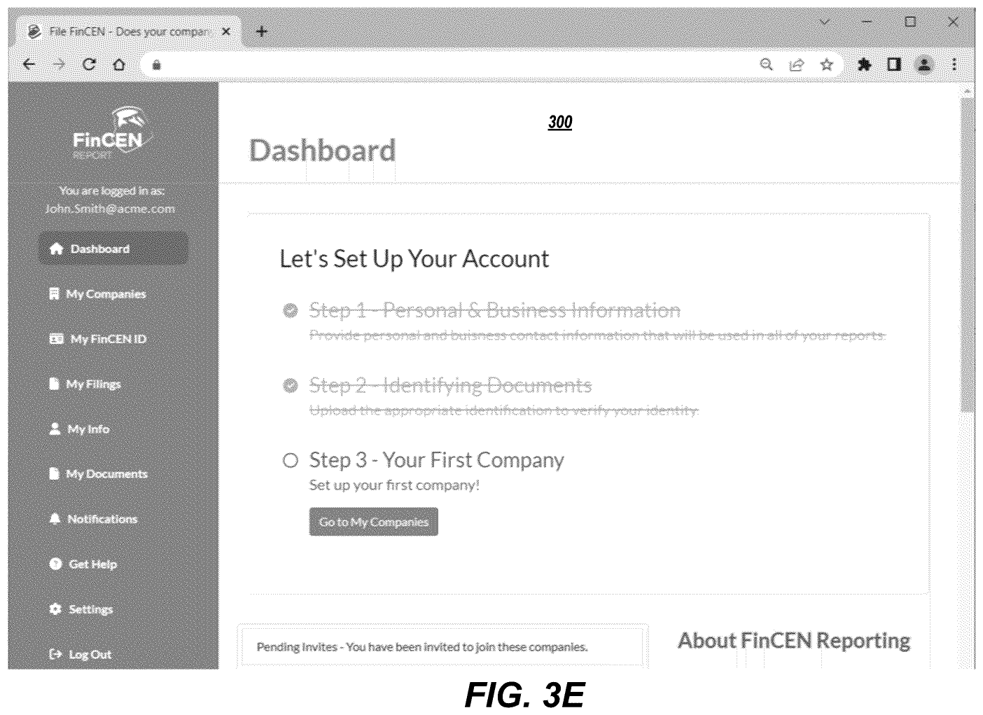

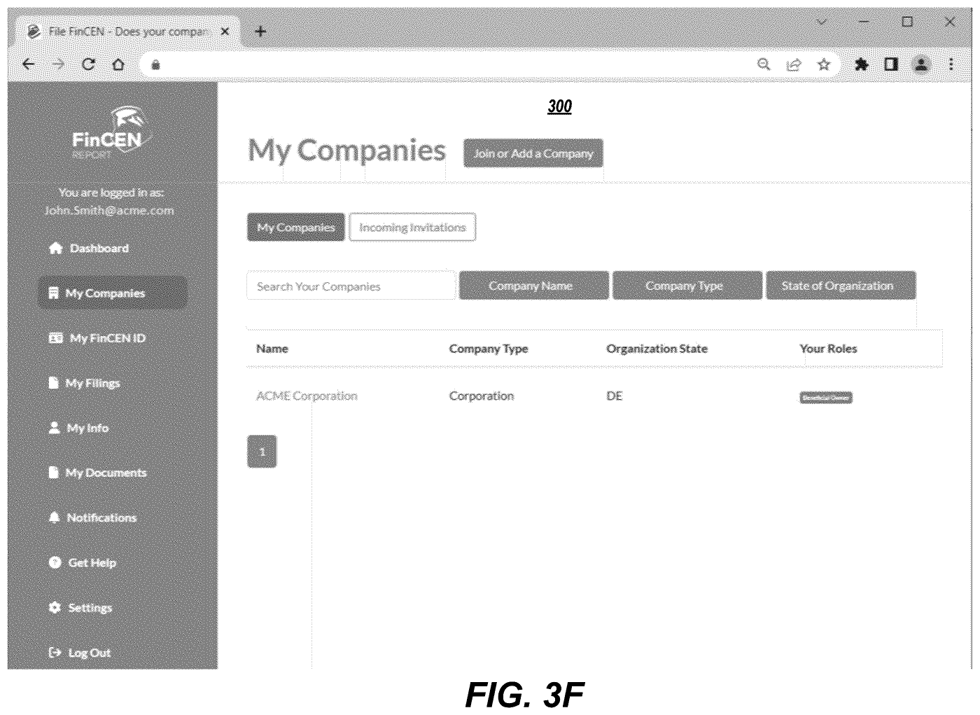

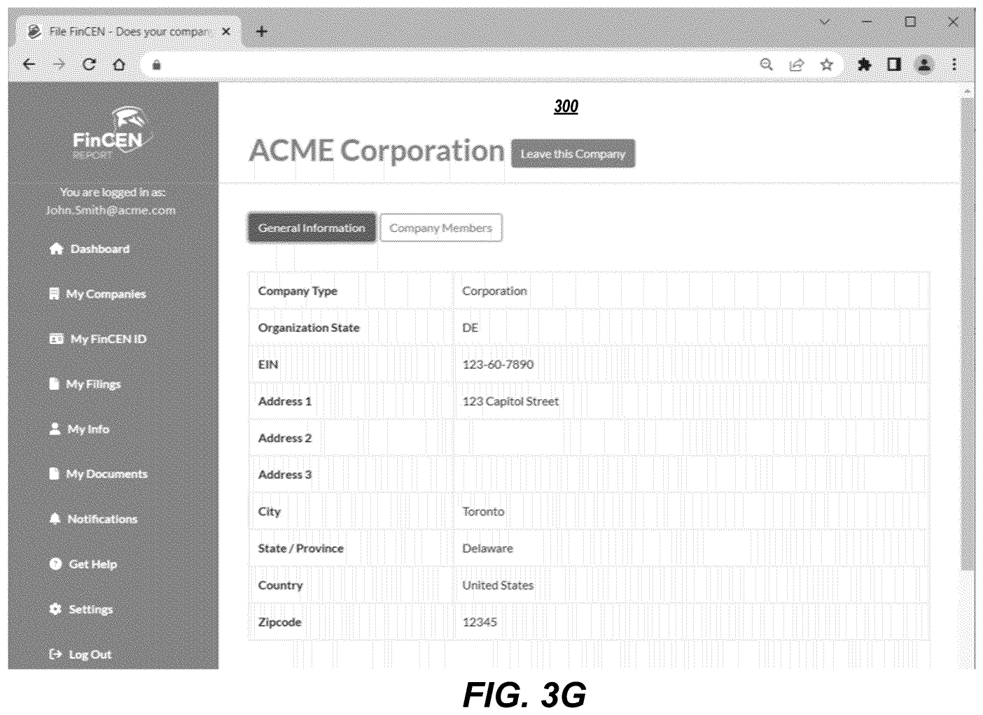

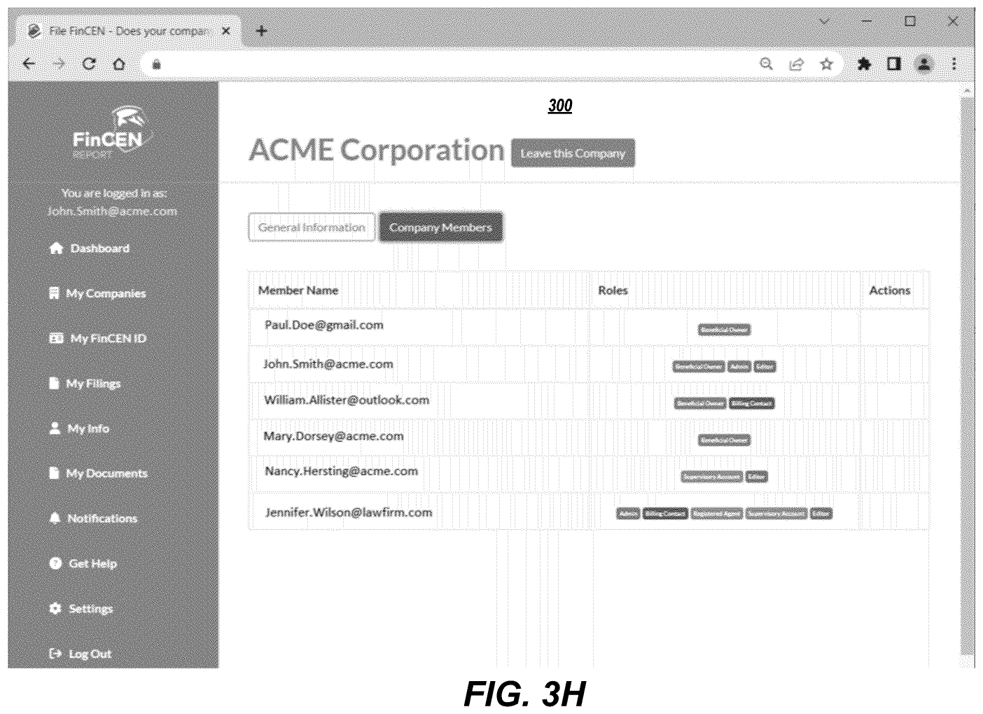

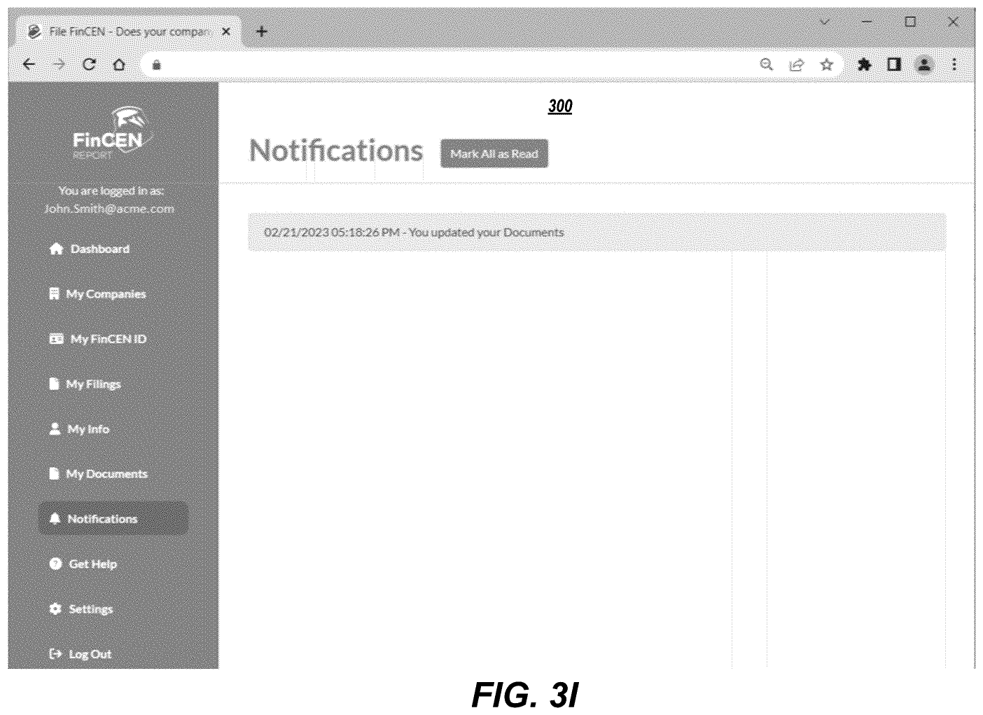

The routine 200 begins at step 202, where the governmental requirements reporting system 100 receives company information for a company, including names, email addresses, and/or other contact information for company members (individuals 102) with a legal interest in the company, such as beneficial owners. The company information and list of company members may be provided by an administrator 106 of the company utilizing a user interface of the governmental requirements reporting system 100, for example, such as portions of the user interface 300 shown in FIGS. 3E-3H. According to some embodiments, the company information and list of company members may be stored as company account data 128 in the governmental requirements reporting data 112 shown in FIGS. 1A and 1B and described herein.

The governmental requirements reporting system 100 may then invite the identified company members (individuals 102) to create accounts in the governmental requirements reporting system, as shown at step 204. For example, the governmental requirements reporting system 100 may send an email to each individual 102 based on the supplied email address.

From step 203, the routine 200 proceeds to step 206, where the governmental requirements reporting system 100 receives general information 124 and PII 122 from the company members (individuals 102) necessary for governmental reporting compliance. For example, upon receiving the email invitation, each individual 102 may visit the governmental requirements reporting system 100, create a secure login, and provide the general information 124 and PII 122 utilizing portions of the user interface 300 shown in FIGS. 3A-3D. The individual's general information 124 and PII 122 may then be stored encrypted in the governmental requirements reporting data 112.

If, at step 208, all of the necessary information (e.g., legal name, date of birth, residential address, unique identifying number, identifying document(s), etc.) has been received from each required individual 102 associated with the company (e.g., beneficial owners), then the routine 200 proceeds to step 210, where the governmental requirements reporting system 100 facilitates filing of governmental requirements reports with the individual PII 122 of each required individual. For example, the governmental requirements reporting system 100 may generate one or more reports in a format compliant with the governmental requirements and submit the generated reports securely over the networks 120 to the electronic governmental report submission system 130. In further embodiments, the governmental requirements reporting system 100 will only submit reports subsequent to obtaining approval(s) from the administrator 106 and/or the company's attorney through the user interface 300. From step 210, the routine 200 ends.

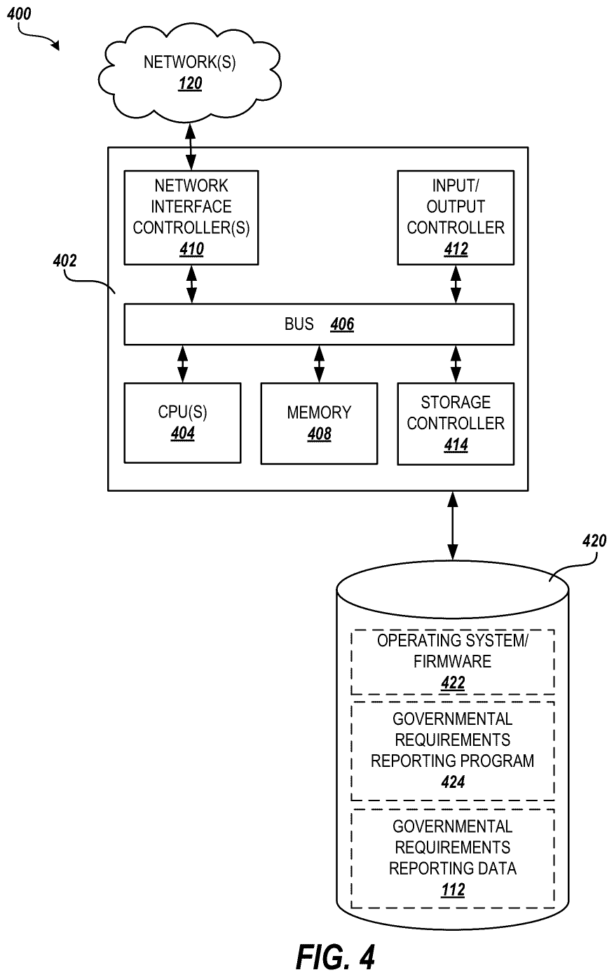

FIG. 4 shows an example computer architecture 400 for a computer 402 capable of executing software components described herein for facilitating individuals and collective organizations to comply with governmental requirements while simultaneously securing the confidentiality and secrecy of each individual's PII. The computer architecture 400 shown in FIG. 4 illustrates a conventional server computer, workstation, desktop computer, laptop, or other computing device, and may be utilized to execute any aspects of the software components presented herein described as executing on the individual's or administrator's computing device 104, the cloud-based server 110, or other computing platform. The computer 402 may include a baseboard, or “motherboard,” which is a printed circuit board to which a multitude of components or devices may be connected by way of a system bus or other electrical communication paths. In one illustrative embodiment, one or more central processing units (“CPUs”) 404 operate in conjunction with a bus 406. The CPUs 404 are standard programmable processors that perform arithmetic and logical operations necessary for the operation of the computer 402.

The CPUs 404 perform the necessary operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, or the like.

The bus 406 provides an interface between the CPUs 404 and the remainder of the components and devices on the baseboard. The bus 406 may provide an interface to a memory 408. The memory 408 may include a random access memory (“RAM”) used as the main memory in the computer 402. The memory 408 may further include a computer-readable storage medium such as a read-only memory (“ROM”) or non-volatile RAM (“NVRAM”) for storing basic routines that that help to start up the computer 402 and to transfer information between the various components and devices. The ROM or NVRAM may also store other software components necessary for the operation of the computer 402 in accordance with the embodiments described herein.

According to various embodiments, the computer 402 may operate in a networked environment using logical connections to remote computing devices through one or more networks, such as the network(s) 120 described above or any other networking topology known in the art that connects the computer 402 to other, remote computers. The bus 406 may include functionality for providing network connectivity through one or more network interface controllers (“NICs”) 410, such as a gigabit Ethernet adapter. It should be appreciated that any number of NICs 410 may be present in the computer 402, connecting the computer to other types of networks and remote computer systems beyond those described herein.

The computer 402 may be connected to a mass storage device 420 that provides non-volatile storage for the computer. The mass storage device 420 may store system programs, application programs, other program modules, and data, which are described in greater detail herein. The mass storage device 420 may be connected to the computer 402 through a storage controller 414 connected to the bus 406. The mass storage device 420 may consist of one or more physical storage units. The storage controller 414 may interface with the physical storage units through a serial attached SCSI (“SAS”) interface, a serial advanced technology attachment (“SATA”) interface, a fiber channel (“FC”) interface, or other standard interface for physically connecting and transferring data between computers and physical storage devices.

The computer 402 may store data on the mass storage device 420 by transforming the physical state of the physical storage units to reflect the information being stored. The specific transformation of physical state may depend on various factors, in different implementations of this description. Examples of such factors may include, but are not limited to, the technology used to implement the physical storage units, whether the mass storage device 420 is characterized as primary or secondary storage, or the like. For example, the computer 402 may store information to the mass storage device 420 by issuing instructions through the storage controller 414 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 402 may further read information from the mass storage device 420 by detecting the physical states or characteristics of one or more particular locations within the physical storage units.

The mass storage device 420 may store an operating system 422 utilized to control the operation of the computer 402. According to some embodiments, the operating system comprises the LINUX operating system. According to another embodiment, the operating system comprises the WINDOWS® SERVER operating system from MICROSOFT Corporation of Redmond, Washington. According to further embodiments, the operating system may comprise the UNIX or SOLARIS operating systems. It should be appreciated that other operating systems may also be utilized. The mass storage device 420 may store other system or application program modules and data utilized by the computer 402, such as the governmental requirements reporting data 112 or a governmental requirements reporting program 424 implementing functionality and user interfaces described herein for facilitating individuals and collective organizations to comply with governmental requirements while simultaneously securing the confidentiality and secrecy of each individual's PII.

In some embodiments, the mass storage device 420 may be encoded with computer-executable instructions that, when loaded into the computer 402, may transform the computer from a general-purpose computing system into a special-purpose computer capable of implementing the embodiments described herein. These computer-executable instructions transform the computer 402 by specifying how the CPUs 404 transition between states, as described above. According to some embodiments, the mass storage device 420 may store computer-executable instructions that, when executed by the computer 402, perform the routine 200 described herein facilitating individuals and collective organizations to comply with governmental requirements while simultaneously securing the confidentiality and secrecy of each individual's PII. In further embodiments, the computer 402 may have access to other computer-readable storage medium in addition to or as an alternative to the mass storage device 420.

The computer 402 may also include an input/output controller 412 for receiving and processing input from a number of input devices, such as a keyboard, a mouse, a touchpad, a touch screen, an electronic stylus, or other type of input device. Similarly, the input/output controller 412 may provide output to a display device, such as a computer monitor, a flat-panel display, a digital projector, a printer, a plotter, or other type of output device.

It will be appreciated that the computer 402 may not include all of the components shown in FIG. 4, may include other components that are not explicitly shown in FIG. 4, or may utilize an architecture completely different than that shown in FIG. 4. For example, the processor(s) 404, memory 408, mass storage devices 420, and NIC(s) 410 of the computer architecture 400 may represent components of a System-on-a-Chip (“SoC”) integrated circuit utilized in a mobile device or smartphone, virtualized resources from any number of server computers or computing devices, or generic processing resources, storage resources, and communication resources of a cloud-based computing system, with the bus 406 representing communication interlinks between the processing, storage, communication, and other computing resources in the cloud-based computing system. It is intended that all such computing architectures be included within the scope of this application.

While the embodiments described above and shown in the figures describe and depict a governmental requirements reporting system 100 for facilitating company compliance with rules promulgated by FinCEN under the CTA, it will be appreciated by one skilled in the art upon reading the instant disclosure that the technologies and methodologies described herein are generally applicable to the collecting of PII for individuals associated with an organization and generating of filings with the PII in compliance with any predefined requirements while simultaneously securing the confidentiality and secrecy of each individual's PII. Further, while the instant description describes an individual's PII as comprising legal name, date of birth, residence address, governmental ID, and identifying document(s), it will be appreciated that other forms of PII may be imagined that could similarly be required for filings in compliance with governmental requirements yet requiring secure storage and confidentiality. It is intended that all such rules, filing requirements, and PII be supported by this disclosure.

Based on the foregoing, it will be appreciated that technologies for facilitating individuals and collective organizations to comply with governmental requirements while simultaneously securing the confidentiality and secrecy of each individual's PII are described herein. The above-described embodiments are merely possible examples of implementations set forth for a clear understanding of the principles of the present disclosure. Many variations and modifications may be made to the above-described embodiments without departing substantially from the spirit and principles of the present disclosure. All such modifications and variations are intended to be included within the scope of the present disclosure, and all possible claims to individual aspects or combinations and sub-combinations of elements or steps are intended to be supported by the present disclosure.

The logical steps, functions or operations described herein as part of a routine, method or process may be implemented (1) as a sequence of processor-implemented acts, software modules or portions of code running on a microcontroller, computing device, or other computer system and/or (2) as interconnected machine logic circuits or circuit modules within the microcontroller, computing device, or other computer system. The implementation is a matter of choice dependent on the performance and other requirements of the system. Alternate implementations are included in which steps, operations or functions may not be included or executed at all, may be executed out of order from that shown or discussed, including substantially concurrently or in reverse order, depending on the functionality involved, as would be understood by those reasonably skilled in the art of the present disclosure.

It will be further appreciated that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

What is claimed is:

1. A method comprising steps of:
receiving, by a governmental requirements reporting system, company information comprising contact information for one or more individuals associated with a company from an administrator associated with the company;
inviting, by the governmental requirements reporting system, each of the one or more individuals associated with the company to access the governmental requirements reporting system;
receiving, by the governmental requirements reporting system, personally identifiable information corresponding to a first individual of the one or more individuals associated with the company, the personally identifiable information received from the corresponding first individual, and storing the received personally identifiable information in a data storage of the governmental requirements reporting system; and
upon receiving personally identifiable information corresponding to each of the one or more individuals associated with the company, generating, by the governmental requirements reporting system, a governmental requirements report in a format compliant with governmental requirements, the governmental requirements report comprising the personally identifiable information corresponding to each of the one or more individuals associated with the company;
wherein the received personally identifiable information corresponding to the first individual is stored in the data storage of the governmental requirements reporting system such that the personally identifiable information may be viewed and modified by the first individual but may not be viewed by the administrator or another of the one or more individuals associated with the company.

2. The method of claim 1, further comprising, upon receiving approval from the administrator, submitting, by the governmental requirements reporting system, the generated governmental requirements report electronically to an electronic governmental report submission system over the Internet.

3. The method of claim 2, further comprising:
upon detecting a change to personally identifiable information corresponding to the first individual, notifying the administrator of the change; and
upon receiving approval from the administrator, generating, by the governmental requirements reporting system, an additional governmental requirements report based on the change in compliance with the governmental requirements and submitting the additional governmental requirements report to the electronic governmental report submission system.

4. The method of claim 1, wherein inviting each of the one or more individuals associated with the company to access the governmental requirements reporting system comprises automatically sending, by the governmental requirements reporting system, an email to the individual based on the contact information for the individual, the email comprising a link allowing the individual to access the governmental requirements reporting system over the Internet.

5. The method of claim 1, wherein the personally identifiable information corresponding to an individual comprises a document validating an identity of the individual in compliance with the governmental requirements.

6. The method of claim 1, wherein the one or more individuals associated with the company represent owners of the company matching a set of rules included in the governmental requirements.

7. The method of claim 6, wherein the governmental requirements comprise rules promulgated by FinCEN under the Corporate Transparency Act of 2020.

8. A non-transitory computer-readable medium encoded with computer-executable instructions that, when executed by processing resources of a computing system; cause the computing system to:
receive company information comprising contact information for one or more individuals associated with a company from an administrator associated with the company;
electronically invite each of the one or more individuals associated with the company to access the governmental requirements reporting system;
receive personally identifiable information corresponding to each of the one or more individuals associated with the company, the personally identifiable information received from the corresponding individual, and storing the received personally identifiable information in a data storage of the computing system; and
upon receiving approval from the administrator, generate a governmental requirements report in a format compliant with governmental requirements, the governmental requirements report comprising the personally identifiable information corresponding to each of the one or more individuals associated with the company, and sending the generated governmental requirements report electronically to an electronic governmental report submission system over the Internet;
wherein the received personally identifiable information corresponding to each individual is stored in the data storage of the governmental requirements reporting system such that the personally identifiable information may be viewed and modified by that individual but may not be viewed by the administrator or another of the one or more individuals associated with the company.

9. The non-transitory computer-readable medium of claim 8, encoded with additional computer-executable instructions that further cause the computing system to:
upon detecting a change to personally identifiable information corresponding to a first individual of the one or more individuals associated with the company, notify the administrator of the change; and
upon receiving approval from the administrator, generate an additional governmental requirements report based on the change in compliance with the governmental requirements and electronically submit the additional governmental requirements report to the electronic governmental report submission system.

10. The non-transitory computer-readable medium of claim 8, wherein inviting each of the one or more individuals associated with the company to access the governmental requirements reporting system comprises sending an email to the individual based on the contact information for the individual, the email comprising a link allowing the individual to access cloud-based servers hosting the computing system over the Internet.

11. The non-transitory computer-readable medium of claim 8, wherein the personally identifiable information corresponding to an individual comprises a document validating an identity of the individual in compliance with the governmental requirements.

12. The non-transitory computer-readable medium of claim 8, wherein the computing system is configured to manage a plurality of companies, each company of the plurality of companies having an administrator and one or more individuals associated with the company.

13. The non-transitory computer-readable medium of claim 8, wherein the data storage of the governmental requirements reporting system further stores one or more roles with respect to the company for each of the one or more individuals associated with the company.

14. The non-transitory computer-readable medium of claim 8, wherein the one or more individuals associated with the company represent owners of the company matching a set of rules included in the governmental requirements.

15. A system comprising:
a data storage;
a client app configured to execute on individual computing devices; and
a cloud computing resource operatively connected to the data storage and connected to the client app executing on a plurality of individual computing devices through one or more networks, the cloud computing resource configured to:
receive via the client app company information from an administrator associated with a company, the company information comprising contact information for one or more individuals associated with the company,
send an email to each of the one or more individuals associated with the company based on the contact information for the individual, the email comprising a link allowing the individual to access the cloud computing resource via the client app,
receive via the client app personally identifiable information corresponding to a first individual of the one or more individuals associated with the company, the personally identifiable information received from the corresponding first individual,
store the received personally identifiable information in the data storage, and
upon receiving personally identifiable information corresponding to each of the one or more individuals associated with the company, generate a governmental requirements report in a format compliant with governmental requirements, the governmental requirements report comprising the personally identifiable information corresponding to each of the one or more individuals associated with the company;
wherein the received personally identifiable information corresponding to the first individual is stored in the data storage such that the personally identifiable information may be viewed and modified via the client app by the first individual but may not be viewed by the administrator or another of the one or more individuals associated with the company.

16. The system of claim 15, wherein the cloud computing resource is further configured to, upon receiving approval from the administrator via the client app, submit the generated governmental requirements report electronically to an electronic governmental report submission system over the one or more networks.

17. The system of claim 16, wherein the cloud computing resource is further configured to:
detect a change to the personally identifiable information corresponding to the first individual made by the first individual via the client app;
upon detecting the change, notify the administrator of the change; and
upon receiving approval from the administrator via the client app, generate an additional governmental requirements report based on the change in compliance with the governmental requirements and submit the additional governmental requirements report to the electronic governmental report submission system.

18. The system of claim 15, wherein the personally identifiable information corresponding to an individual comprises a document validating an identity of the individual in compliance with the governmental requirements.

19. The system of claim 15, wherein the one or more individuals associated with the company represent owners of the company matching a set of rules included in the governmental requirements.

20. The system of claim 19, wherein the governmental requirements comprise rules promulgated by FinCEN under the Corporate Transparency Act of 2020.
